(19) United States
(12) Patent Application Publication
(10) Pub. No.: US 2009/0137137 A1
(43) Pub. Date: May 28, 2009

(54) PORTABLE MEMORY DEVICE SUPPORTING A PLURALITY OF INTERFACES

(75) Inventors: Seong-hun JEONG, Suwon-si (KR); Mi-hwa Park, Anyang-si (KR); Houng-sog Min, Ansab-sil (KR); Yong-je Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/270,907

(22) Filed: Nov. 14, 2008

(30) Foreign Application Priority Data
Nov. 26, 2007 (KR) 2007-120977

(51) Int. Cl. H01R 13/44

(52) U.S. Cl. 439/131

(57) ABSTRACT

A portable memory device supporting a plurality of interfaces includes a body, a first connector disposed on an end of the body, a slider adjacent to the body so as to slide back and forth between a first position exposing the first connector and a second position covering the first connector, a second connector disposed on an end of the slider to connect the portable memory device to another electronic device via an interface different from an interface that the first connector supports, and a memory disposed inside the body and connected to the first connector and the second connector.

### CROSS-REFERENCE TO RELATED APPLICATIONS

This application claims the benefit of Korean Patent Application No. 10-2007-0120977, filed on Nov. 26, 2007, in the Korean Intellectual Property Office, the disclosure of which is incorporated herein in its entirety by reference.

### BACKGROUND OF THE INVENTION

1. Field of the Invention

The present general inventive concept relates to a portable memory device, and more particularly, to a portable memory device supporting a plurality of interfaces to connect the portable memory device to another electronic device.

2. Description of the Related Art

Portable memory devices, which can be connected to computers, portable media players (PMPs), cellular phones, digital cameras, etc., are widely used nowadays to provide easy data transmission from an electronic device to another electronic device, and are used to expand storage capacity. However, it is difficult to use the portable memory devices in the aforestated applications, because manufacturers of the portable memory devices utilize different types of interfaces such as universal serial bus (USB) interface, a secure digital (SD) card interface, a multimedia card (MMC) interface, a compact flash card (CFC) interface, etc. Currently, portable memory devices can be connected to another electronic device by using an extension cord, one end of which has a male connector as one interface and the other end of which has a female connector as another interface. Thus there are demands to eliminate this inconvenience.

### SUMMARY OF THE INVENTION

The present general inventive concept provides a portable memory device supporting a plurality of interfaces to connect the portable memory device to another electronic device, thus improving compatibility.

Additional aspects and utilities of the present general inventive concept will be set forth in part in the description which follows and, in part, will be obvious from the description, or may be learned by practice of the general inventive concept.

The foregoing and/or additional aspects and utilities of the present general inventive concept may be achieved by providing a portable memory device including a body, a first connector disposed on an end of the body, a slider adjacent to the body and slidable thereon between a first position exposing the first connector and a second position covering the first connector, a second connector disposed on an end of the slider to connect the portable memory device to another electronic device via an interface different from an interface supported by the first connector, and a memory unit disposed inside the body and connected to the first connector and the second connector.

The portable memory device may further include a cover covering the slider so that the first connector is exposed when the slider is in the first position.

The portable memory device may further include a shifting protrusion that is fixedly formed on the slider to move the slider between the first and second position.

The first connector and the second connector may be connected to the memory unit via independent connections.

The second connector may be connected to the first connector when the slider is in the second position.

The first connector may include a plurality of connecting terminals such that a total number of connecting terminals of the second connector may be smaller than a total number of the connecting terminals of the first connector, and the connecting terminals of the first connector may be respectively connected to the connecting terminals of the second connector, while at least one of the connecting terminals of the first connector is disconnected from any of the connecting terminals of the second connector.

The first connector and the second connector may include the same number of connecting terminals, and the connecting terminals of the first connector may be respectively connected to the connecting terminals of the second connector.

The foregoing and/or additional aspects and utilities of the present general inventive concept may also be achieved by providing a portable memory device including a body, a memory unit disposed inside the body, a first connector disposed at an end of the body and connected to the memory unit, a second connector disposed at the other end of the body and connected to the memory unit, and a slider adjacent to the body and slidable thereon back and forth between a first position exposing the first connector while covering the second connector and a second position covering the first connector while exposing the second connector.

The portable memory device may further include a cover covering the slider so that the first connector is fully exposed.

The portable memory device may further include a shifting protrusion to move the slider between the first position and the second position.

The foregoing and/or additional aspects and utilities of the present general inventive concept may also be achieved by providing a portable memory device including a body, a first connector disposed on a front surface of an end of a protrusion protruding from the body in a predetermined direction, a second connector disposed in a lateral surface of an end of the protrusion to connect the portable memory device to an electronic device via an interface different from an interface supported by the first connector, and a memory unit disposed inside the body and connected to the first connector and the second connector.

The first connector and the second connector may be connected to the memory unit through independent connections.

The second connector may be connected to the first connector.

The first connector may include a plurality of connecting holes to connect the first connector to another electronic device having connectors having a plurality of protruding connecting pins corresponding to complementary connecting pins housed by the connecting holes of the first connector. A total number of connecting terminals of the second connector may be smaller than a total number of the complementary connecting pins of the first connector. A plurality of the complementary connecting pins of the first connector may be respectively connected to the connecting terminals of the second connector while at least one of the complementary connecting pins of the first connector is not connected to the connecting terminals of the second connector.

The first connector may include a plurality of the connecting holes in order to connect the first connector to another electronic device having connectors having a plurality of protruding connecting pins corresponding to complementary connecting pins housed by the connecting holes of the first connector. A total number of connecting terminals of the second connector may be equal to a total number of the complementary connecting pins of the first connector. The complementary connecting pins of the first connector may be respectively connected to the connecting terminals of the second connector.

The foregoing and/or additional aspects and utilities of the present general inventive concept may also be achieved by providing a portable memory device including a body, a memory unit enclosed in the body to store data, a first connector having a first arrangement of terminals coupled to the memory unit and corresponding to a first interface thereto, and a second connector having a second arrangement of terminals coupled to the memory unit and corresponding to a second interface thereto, the second interface being other than the first interface.

The foregoing and/or additional aspects and utilities of the present general inventive concept may also be achieved by providing a portable memory device including a body, a memory unit enclosed in the body to store data, a first interface unit corresponding to a first interface to the memory unit and having first connector with a first arrangement of terminals corresponding to the first interface, and a second interface unit corresponding to a second interface to the memory unit other than the first interface, the second interface unit having a second connector with a second arrangement of terminals corresponding to the second interface

### BRIEF DESCRIPTION OF THE DRAWINGS

The above and other features and advantages of the present general inventive concept will become more apparent by describing in detail exemplary embodiments thereof with reference to the attached drawings in which:

FIGS. 1A and 1B are perspective views of a portable memory device according to an embodiment of the present general inventive concept, where FIG. 1A illustrates a configuration by which the portable memory device may be connected to another device via a first connector and FIG. 1B illustrates a configuration by which the portable memory device may be connected to another device via a second connector;

FIG. 2 is a cross-sectional view of the portable memory device of FIG. 1B, taken along line II-II;

FIGS. 3A and 3B are block diagrams of the portable memory device according to an embodiment of the present general inventive concept;

FIGS. 4A and 4B are perspective views of a portable memory device according to another embodiment of the present general inventive concept, where FIG. 4A illustrates a configuration by which the portable memory device may be connected to another device via a first connector and FIG. 4B illustrates a configuration by which the portable memory device may be connected to another device via a second connector;

FIG. 5 is an perspective view of a portable memory device according to another embodiment of the present general inventive concept; and

FIG. 6 is a cross-sectional view of the portable memory device of FIG. 5, taken along line IV-IV.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

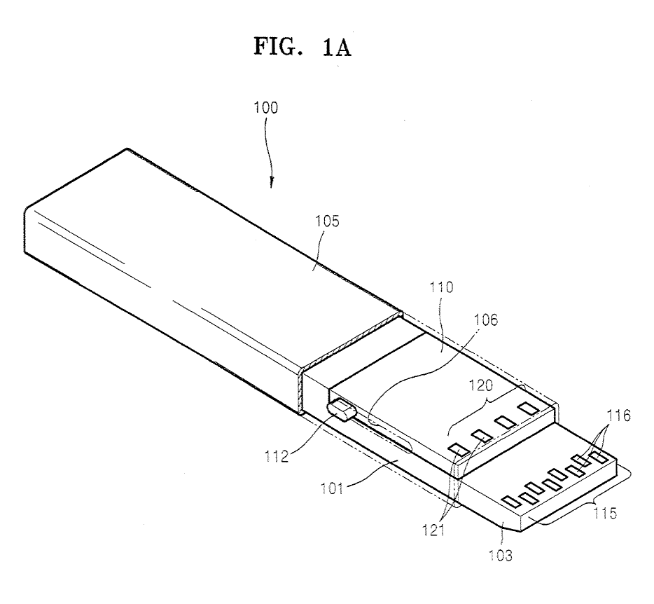

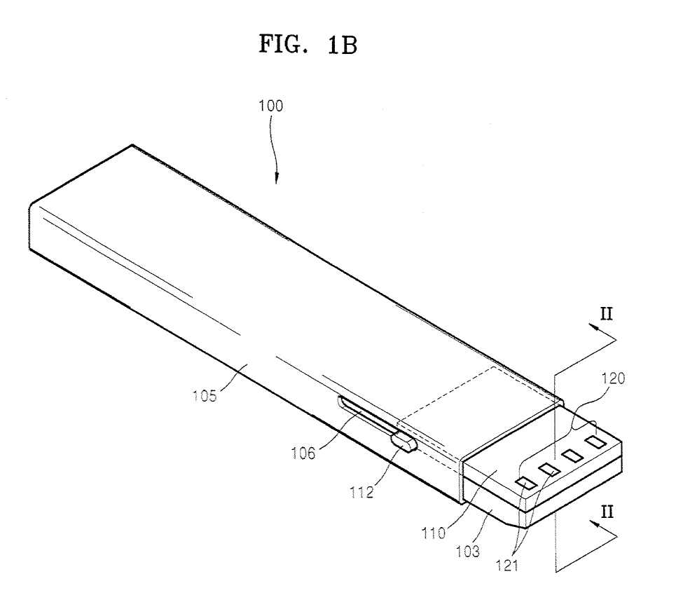

FIGS. 1A and 1B are perspective views of a portable memory device 100 according to an embodiment of the present general inventive concept, where FIG. 1A illustrates the portable memory device 100 in a configuration to be connected to another device via a first connector 115 and FIG. 1B illustrates the portable memory device 100 in a configuration to be connected to another device via a second connector 120.

Referring to FIGS. 1A and 1B, the portable memory device 100 includes a body 101, a slider 110 which is positioned adjacent to the body 101 to slide thereon, and a cover 105 covering the body 101 and the slider 110. A protrusion 103 may extend from one end of the body 101 and external to the cover 105. The first connector 115 may be disposed on an end of the protrusion 103 to connect the portable memory device 100 to another electronic device, such as a computer, a portable media player (PMP), a cellular phone, a digital camera, etc., for data exchange. For example, the first connector 115 may be a connector supporting one of many interfaces, such as universal serial bus (USB), a secure digital (SD) card, a multimedia card (MMC), and may include a plurality of connecting terminals 116.

The slider 110 is attached to the body 101 in order for the slider 110 to slide back and forth between a first position (as illustrated in FIG. 1A) exposing the first connector 115 and a second position (as illustrated FIG. 1B) covering the first connector 115. The second connector 120 is disposed on an end of the slider 110 to connect the portable memory device 100 to another electronic device via an interface different from the interface supported by the first connector 115. For example, an interface corresponding to the second connector 120 may support one of USB, a SD card, a MMC, etc., but is different from the interface that the first connector 115 supports. The second connector 120 also includes a plurality of connecting terminals 121. Although the second connector 120 is illustrated as having fewer connecting terminals 121 than those of the first connector 115 in FIG. 1A, the present general inventive concept is not limited thereto, and thus, the first and second connectors 115 and 120 may have the same number of connecting terminals, or the second connector 120 may have more connecting terminals than the first connector 115.

When the slider 110 is in a first position, the slider 110 may be retracted into the cover 105, whereby only the first connector 115 is exposed (as illustrated in FIG. 1A). When the slider 110 is in a second position, the connecting terminals of the first connector 115 may be covered by the slider 110, and thus only the connecting terminals of the second connector 120 are exposed (as illustrated in FIG. 1B). Therefore, the present general inventive concept, as embodied in the portable memory device 100, may have a simple and sleek shape.

The portable memory device 110 may include a shifting protrusion 112 protruding through a slot 106 formed, for example, in a side surface of the cover 105 and extending along a direction in which the slider 110 slides back and forth between the first and second position. It is to be understood that the sliding protrusion 112 and the slot 106 may be located on the portable memory device 110 at other than the side surface thereof. The sliding protrusion 112 may be fixed to the slider 110 such that by pressing the shifting protrusion 112 to move along the slot 106, the slider 110 can be easily moved from the first position to the second position and vice versa.

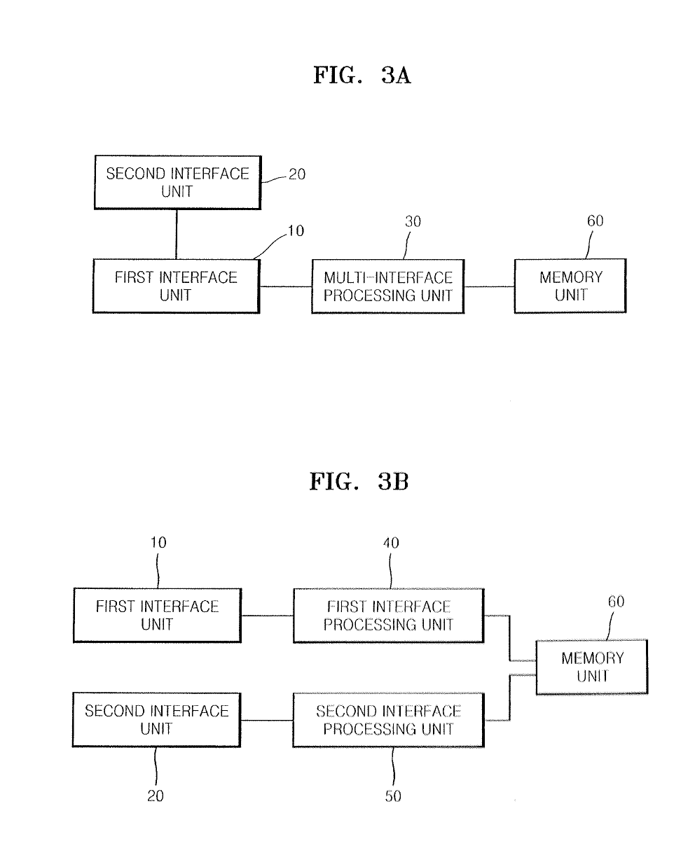

FIGS. 3A and 3B are block diagrams of a portable memory device 100 according to an embodiment of the present general inventive concept.

Referring to FIG. 3A, the portable memory device includes a first interface unit 10, a second interface unit 20, a multi-interface processing unit 30, and a memory unit 60. The first interface unit 10 may include the first connector 115 (as illustrated in FIG. 1A), and the second interface unit 20 may include the second connector 120 (as illustrated in FIGS. 1A and 1B). When the portable memory device is connected to an electronic device via either the first interface unit 10 or the second interface unit 20, the multi-interface processing unit 30 determines the interface unit from among the first and second interface units 10 and 20 by which the portable memory device is connected to the electronic device, and provides an indication to the electronic device that a connection is established between the portable memory device and the electronic device, such as by a suitably formatted signal, so that data can be exchanged therebetween.

The memory unit 60 may include a semiconductor memory chip, which provides a data storage space, and a controller to control the semiconductor memory chip. While the first interface unit 10 may be directly connected to the multi-interface processing unit 30 and the memory unit 60, as illustrated in FIG. 3A, the second interface unit 20 may be connected to both the multi-interface processing unit 30 and the memory unit 60 via the first interface unit 10.

A portable memory device according to the present general inventive concept may also be embodied as illustrated in FIG. 3B. In other words, the portable memory device may include the first interface unit 10 including the first connector 115 (as illustrated in FIG. 1A), a first interface processing unit 40 connected directly to the first interface unit 10, the second interface unit 20 including the second connector 120 (as illustrated in FIGS. 1A and 1B), a second interface processing unit 50 connected directly to the second interface unit 20, and the memory unit 60.

When the portable memory device is connected to an electronic device via the first interface unit 10, the first interface processing unit 40 provides an indication to the electronic device that a connection is established between the portable memory device and the electronic device via the first interface unit 10, such as by a suitably formatted signal, so that data can be exchanged therebetween. When the portable memory device is connected to an electronic device via the second interface unit 20, the second interface processing unit 50 may provide a suitably formatted signal to the electronic device that the connection is established between the portable memory device and the electronic device via the second interface unit 20 so that data can be exchanged therebetween.

The memory unit 60 may be disposed inside the body 101 illustrated in FIGS. 1A and 1B, and may include a semiconductor memory chip, which provides a data storage space, and a controller controlling the semiconductor memory chip. The memory unit 60 may be independently accessed through the first connector 115 (illustrated in FIG. 1A) of the first interface unit 10 and the second connector 120 of the second interface unit 20 via the first interface processing unit 40 and the second interface processing unit 50, respectively.

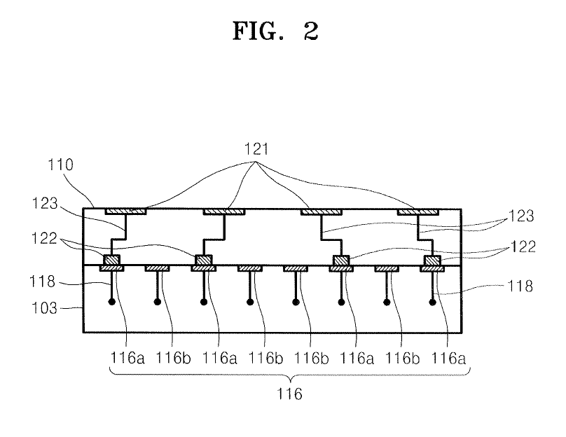

FIG. 2 is a cross-sectional view of the portable memory device 100 of FIG. 1B, taken along line II-II, illustrating a configuration in which the second interface unit 20, described above with reference to FIG. 3A, is connected to the multi-interface processing unit 30 and the memory unit 60 via the first interface unit 10. Referring to FIG. 2, four connecting wires 123, respectively extending from the four connecting terminals 121 of the second connector 120 (refer to FIGS. 1A and 1B) to the surface of the protrusion 103 facing the slider 110, are disposed inside the slider 110. The connecting wires 123 may each be terminated by a suitable sliding contact terminal 122 to make sufficient electrical contact with the corresponding connecting terminals 116 while allowing the slider 110 to be retracted out of the second position and into the first position. Such sliding contact terminal 122 may be implemented by an elastically biased contact. Additionally, eight connecting wires 118, respectively extending from the eight connecting terminals 116 of the first connector 115 to the multi-interface processing unit 30 (refer to FIG. 3A), are disposed inside the protrusion 103.

When the slider 110 is in the second position, the four connecting wires 123 are connected to only four predetermined connecting terminals 116a of the eight connecting terminals 116 of the first connector 115, as illustrated in FIG. 1A, and are not connected to the other four connecting terminals 116b of the eight connecting terminals 116 of the first connector 115. Therefore, if the portable memory device 100 is connected to an electronic device via the second connector 120 when the slider 110 is in the second position, signals received at the multi-interface processing unit 30 via only the four connecting wires 118, i.e., those connected to the predetermined connecting terminals 116a, of the eight connecting wires 118 of the first connector 115. The multi-interface processing unit 30 determines that the portable memory device is connected to another electronic device via the second connector 120 if the signals are input via only the four specific predetermined wires 118. If the signals are input via the eight connecting wires 118 other than the four predetermined wires, the multi-interface processing unit 30 determines that the portable memory device is connected to another electronic device via the first connector 115.

The multi-interface processing unit 30 can also determine to which of the first and second connectors 115 and 120 an electronic device is connected based on differences between patterns of the signals received. In other words, since different types of interfaces cause different patterns of corresponding signals, the multi-interface processing unit 30 can determine to which of the first and second connectors 115 and 120 an electronic device is connected based on the differences between the patterns of the received signals even when the first and second connectors 115 and 120 have the same number of connecting terminals.

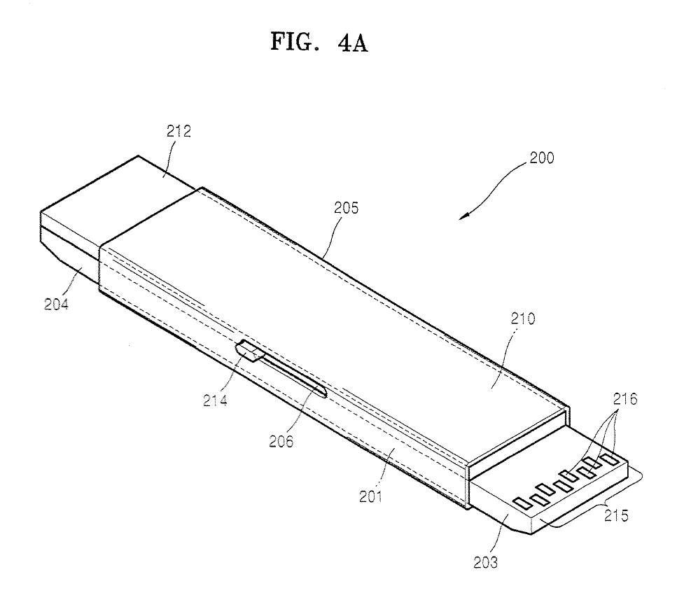

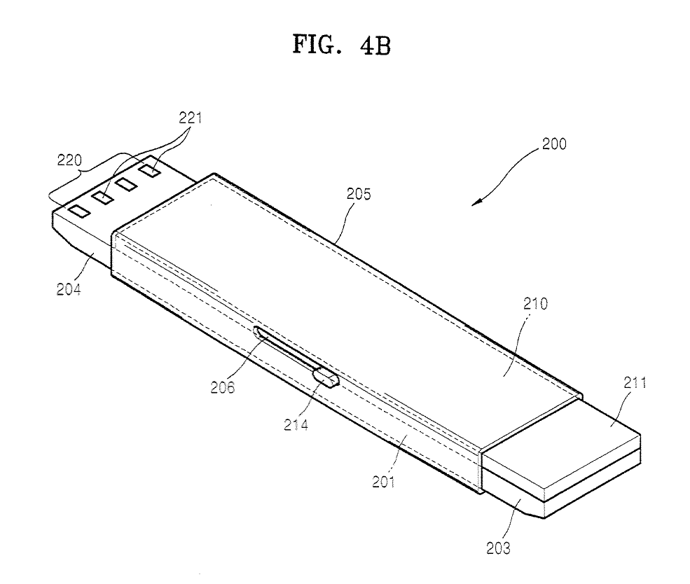

FIGS. 4A and 4B are perspective views of a portable memory device 200 according to another embodiment of the present general inventive concept, where FIG. 4A illustrates a configuration in which the portable memory device 200 may be connected to another device via a first connector 215, and FIG. 4B illustrates a configuration in which the portable memory device 200 may be connected to another device via a second connector 220.

Referring to FIGS. 4A and 4B, the portable memory device 200 includes a body 201, a slider 210 which is adjacent to the body 201 so as to slide thereon, and a cover 205 covering the body 201 and the slider 210. A first protrusion 203 extends outward from one end of the cover 205, and a second protrusion 204 extends outward from the other end of the cover 205. The first connector 215 and the second connector 220 are disposed on the ends of the first protrusion 203 and the second protrusion 204, respectively, to connect the portable memory device 200 to another electronic device such as a computer, a PMP, a cellular phone, a digital camera, etc., for data exchange. For example, the first connector 215 and the second connector 220 may be connectors supporting interfaces such as USB, a SD card, a MMC, etc.; however the first connector 215 and the second connector 220 may support different interfaces from each other. The first connector 215 and the second connector 220 include a plurality of connecting terminals 216 and 221, respectively, and the first connector 215 and the second connector 220 may have a different number of connecting terminals.

The slider 210 is positioned adjacent to the body 201 so as to slide back and forth between a first position (as illustrated in FIG. 4A) exposing the connecting terminals 216 of the first connector 215 while covering the second connector 220, and a second position (as illustrated FIG. 4B) covering the first connector 215 while exposing the connecting terminals 221 of the second connector 220.

When the slider 210 is in the first position illustrated in FIG. 4A, a first protrusion 211 (illustrated in FIG. 4B) at an end of the slider 210 is retracted into the cover 205 thereby exposing the connecting terminals 216 of the first connector 215, while a second protrusion 212 at the opposite end of the slider 210, extends from the cover 205 thereby exposing the protrusion 212 and covering the second connector 220. On the other hand, when the slider 210 is at the second position (as illustrated in FIG. 4B), the first protrusion 211 of the slider 210 extends from the cover 205 to cover the first connector 215 and the second protrusion 212 (illustrated in FIG. 4A) of the slider 210 is retracted into the cover 205 thereby exposing the second connector 220.

The portable memory device 200 may include a shifting protrusion 214 extending through a slot 206 formed, for example, in a side surface of the cover 205 along a direction in which the slider 210 slides back and forth. The shifting protrusion 214 may be fixed to the slider 210. By pressing the shifting protrusion 214 to move along the slot 206, the slider 210 can be easily moved from the first position to the second position and vice versa.

Certain functional components of the portable memory device 200 may be implemented in a configuration similar to that illustrated in FIG. 3B. In other words, the portable memory device 200 may include the first interface unit 10 including the first connector 215 illustrated in FIG. 4A, the first interface processing unit 40 connected directly to the first interface unit 10, the second interface unit 20 including the second connector 220 illustrated in FIG. 4B, the second interface processing unit 50 connected directly to the second interface unit 20, and the memory unit 60.

When the portable memory device 200 is connected to an electronic device via the first interface unit 10, the first interface processing unit 40 may provide an indication to the electronic device that a connection is established between the portable memory device 200 and the electronic device via the first connector 215, such as through a suitably formatted signal, so that data can be exchanged therebetween. When the portable memory device 200 is connected to an electronic device via the second interface unit 20, the second interface processing unit 50 may provide a signal to the electronic device that a connection is established between the portable memory device and the electronic device via the second connector 220 so that data can be exchanged therebetween.

The memory unit 60 may be disposed inside the body 201, and may include a semiconductor memory chip providing a data storage space, and a controller controlling the semiconductor memory chip. The memory unit 60 may be independently accessed through the first connector 215 of the first interface unit 10 and the second connector 220 of the second interface unit 20 via the first interface processing unit 40 and the second interface processing unit 50, respectively.

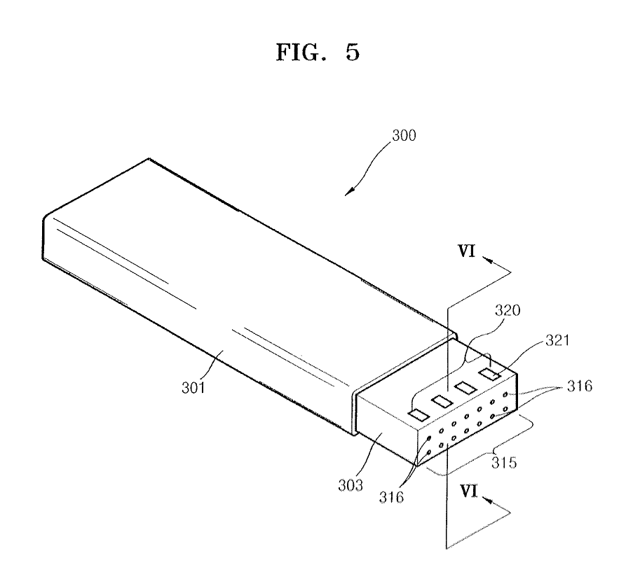

FIG. 5 is a perspective view of a portable memory device 300 according to another embodiment of the present general inventive concept.

Referring to FIG. 5, the portable memory device 300 includes a body 301 and a protrusion 303 extending from the body 301 in a predetermined direction. A first connector 315 and a second connector 320 may be disposed on the front surface and lateral surface, respectively, of an end of the protrusion 303 to connect the portable memory device 300 to another electronic device such as a computer, a PMP, a cellular phone, a digital camera, etc.

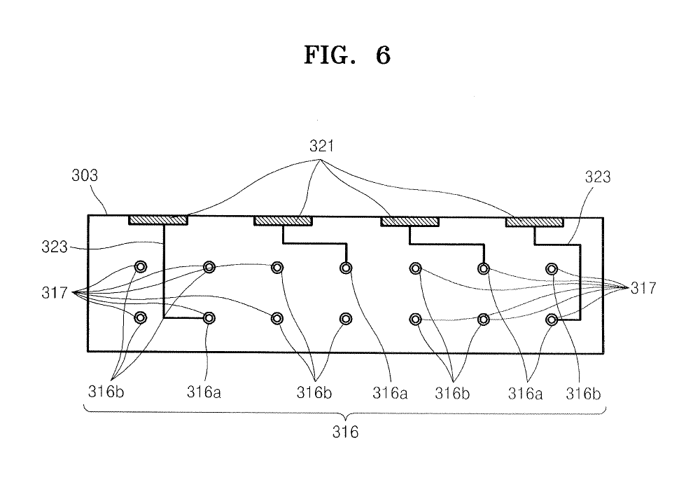

For example, the first connector 315 may be a connector supporting a compact flash card (CFC) interface. To connect the first connector 315 to a connector (not illustrated) of another electronic device having a plurality of protruding connecting pins (not illustrated), the first connector 315 includes a plurality of connecting holes 316 respectively housing complementary connecting pins 317, as illustrated in FIG. 6. The second connector 320 may be a connector supporting an interface, such as USB, a SD card, a MMC, etc., and may include a plurality of connecting terminals 321. The number of the complementary connecting pins 317 of the first connector 315 may be greater than the number of the connecting terminals 321 of the second connector 320.

Certain functional components of the portable memory device 300 may be implemented in a configuration similar to that illustrated in FIG. 3A. In other words, the first interface unit 10 may include the first connector 315, the multi-interface processing unit 30 may be connected directly to the first interface unit 10, the second interface unit 20 may include the second connector 320 and may be connected to the multi-interface processing unit 30 via the first interface unit 10, and the memory unit 60.

When the portable memory device 300 is connected to an electronic device via either the first interface unit 10 or the second interface unit 20, the multi-interface processing unit 30 determines the interface unit from among the first and second interface units 10 and 20 via which the portable memory device 300 is connected to the electronic device, and provides an indication to the electronic device that the connection is established between the portable memory device 300 and the electronic device, such as by a suitably formatted signal, so that data can be exchanged therebetween. The memory unit 60 may include a semiconductor memory chip, which provides a data storage space, and a controller controlling the semiconductor memory chip.

FIG. 6 is a cross-sectional view of the portable memory device 300 of FIG. 5, taken along line IV-IV, illustrating a configuration in which the second interface unit 20 is connected to the multi-interface processing unit 30 and the memory unit 60 via the first interface unit 10. Referring to FIG. 6, four connecting wires 323 connect the four connecting terminals 321 of the second connector 320 illustrated in FIG. 5 respectively to connecting pins 317 in four predetermined connecting holes 316a of the fourteen connecting holes 316 of the first connector 315 illustrated in FIG. 5. The connecting wires 323 may be disposed inside the protrusion 303. The other ten connecting holes 316b of the fourteen connecting holes 316 may be electrically disconnected from the connecting terminals 321. Although not illustrated in detail, the any and all of the connecting pins 317 in the fourteen connecting holes 316 may be connected to the multi-interface processing unit 30 (illustrated in FIG. 3A).

If the portable memory device 300 is connected to another electronic device via the second connector 320, signals are received at the multi-interface processing unit 30 via the connecting wires 323 connected to the connecting pins 317 in the four predetermined connecting holes 316a of the fourteen connecting holes 316 of the first connector 315. The multi-interface processing unit 30 may determine that the portable memory device 300 is connected to another electronic device via the second connector 320 if the signals are input only on connections corresponding to the four specific predetermined connecting holes 316a. If the signals are input via any other of the fourteen connecting holes 316, such as connecting holes 316b, the multi-interface processing unit 30 determines that the portable memory device 300 is connected to another electronic device via the first connector 315.

Also, certain functional components of the portable memory device 300 according to the present embodiment may be implemented in a configuration similar to that illustrated in FIG. 3B. In other words, the portable memory device 300 may include the first interface unit 10 including the first connector 315, the first interface processing unit 40 connected directly to the first interface unit 10, the second interface unit 20 including the second connector 320, the second interface processing unit 50 connected directly to the second interface unit 20, and the memory unit 60.

When the portable memory device 300 is connected to an electronic device via the first interface unit 10, the first interface processing unit 40 may provide an indication to the electronic device that the connection is established between the portable memory device and the electronic device via the first connector 315, such as by a suitably formatted signal, so that data can be exchanged therebetween. When the portable memory device 300 is connected to an electronic device via the second interface unit 20, the second interface processing unit 50 may signal the electronic device that the connection is established between the portable memory device and the electronic device via the second connector 320 so that data may be exchanged therebetween.

The memory unit 60 may be disposed inside the body 301, and may include a semiconductor memory chip, which provides a data storage space, and a controller controlling the semiconductor memory chip. The memory unit 60 may be independently accessed through the first connector 315 of the first interface unit 10 and the second connector 320 of the second interface unit 20 via the first interface processing unit 40 and the second interface processing unit 50, respectively.

Since a portable memory device according to the present general inventive concept supports a plurality of interfaces, the inconvenience or the incompatibility caused by different types of interfaces can be prevented.

Also, since the portable memory device according to the present general inventive concept is configured in such a manner that connectors employing different types of interfaces can overlap one another, the portable memory device can have the same size as portable memory devices having only one connector. Thus, the portable memory device according to the present general inventive concept is highly efficient, multi-functional, and highly portable.

Also, the portable memory device according to the present general inventive concept may be configured to expose only one of the connectors by using a slider that can cover the other one of the connectors that is not in use, and thus the portable memory device can have a simple and sleek shape.

While the present general inventive concept has been particularly shown and described with reference to exemplary embodiments thereof, it will be understood by one of ordinary skill in the art that various changes in form and details may be made therein without departing from the spirit and scope of the present general inventive concept as defined by the following claims.

What is claimed is:

1. A portable memory device comprising:
a body;
a first connector disposed on an end of the body;
a slider adjacent to the body and slidable thereon between a first position exposing the first connector and a second position covering the first connector;
a second connector disposed on an end of the slider to connect the portable memory device to another electronic device via an interface different from an interface supported by the first connector; and
a memory unit disposed inside the body and connected to the first connector and the second connector.

2. The portable memory device of claim 1, further comprising:
a cover covering the slider so that the first connector is exposed when the slider is in the first position.

3. The portable memory device of claim 2, further comprising:
a shifting protrusion that is fixedly formed on the slider to move the slider between the first and second position.

4. The portable memory device of claim 1, wherein the first connector and the second connector are connected to the memory unit via independent connections.

5. The portable memory device of claim 1, wherein the second connector is connected to the first connector when the slider is in the second position.

6. The portable memory device of claim 5, wherein the first connector comprises a plurality of connecting terminals such that a total number of connecting terminals of the second connector is smaller than a total number of the connecting terminals of the first connector, and the connecting terminals of the first connector are respectively connected to the connecting terminals of the second connector while at least one of the connecting terminals of the first connector is disconnected from any of the connecting terminals of the second connector.

7. The portable memory device of claim 5, wherein the first connector and the second connector comprise the same number of connecting terminals, and the connecting terminals of the first connector are respectively connected to the connecting terminals of the second connector.

8. A portable memory device comprising:
a body;
a memory unit disposed inside the body;
a first connector disposed at an end of the body and connected to the memory unit;
a second connector disposed at the other end of the body and connected to the memory unit; and
a slider adjacent to the body and slidable thereon back and forth between a first position exposing the first connector while covering the second connector and a second position covering the first connector while exposing the second connector.

9. The portable memory device of claim 8, further comprising:
a cover covering the slider so that the first connector is fully exposed when the slider is in the first position.

10. The portable memory device of claim 9, further comprising:
a shifting protrusion to move the slider between the first position and the second position.

11. A portable memory device comprising:
a body;
a first connector disposed on a front surface of an end of a protrusion protruding from the body in a predetermined direction;
a second connector disposed in a lateral surface of the end of the protrusion to connect the portable memory device to an electronic device via an interface different from an interface supported by the first connector; and
a memory unit disposed inside the body and connected to the first connector and the second connector.

12. The portable memory device of claim 11, wherein the first connector and the second connector are connected to the memory unit through independent connections.

13. The portable memory device of claim 11, wherein the second connector is connected to the first connector.

14. The portable memory device of claim 13, wherein the first connector comprises a plurality of connecting holes to connect the first connector to another electronic device having connectors including a plurality of protruding connecting pins corresponding to complementary connecting pins housed by the connecting holes of the first connector, a total number of connecting terminals of the second connector is smaller than a total number of the complementary connecting pins of the first connector, and a plurality of the complementary connecting pins of the first connector are respectively connected to the connecting terminals of the second connector, while at least one of the complementary connecting pins of the first connector is disconnected from any of the connecting terminals of the second connector.

15. The portable memory device of claim 13, wherein the first connector comprises a plurality of connecting holes to connect the first connector to another electronic device having connectors including a plurality of protruding connecting pins corresponding to complementary connecting pins housed by the connecting holes of the first connector, a total number of the connecting terminals of the second connector is equal to a total number of the complementary connecting pins of the first connector, and the complementary connecting pins of the first connector are respectively connected to the connecting terminals of the second connector.
